(19) United States
(12) Patent Application Publication
(10) Pub. No.: US 2012/0191528 A1
(43) Pub. Date: Jul. 26, 2012

(54) PRICING AND PAYMENT ALLOCATION AMONG ONLINE ADVERTISING PARTIES

(75) Inventors: Eric Theodore Bax, Altadena, CA (US); Nilanjan Roy, Pasadena, CA (US); James Li, Los Angeles, CA (US)

(73) Assignee: Yahoo! Inc., Sunnyvale, CA (US)

(21) Appl. No.: 13/014,386

(22) Filed: Jan. 26, 2011

(51) Int. Cl. G06Q 30/00

(52) U.S. Cl. 705/14.41; 705/14.7

(57) ABSTRACT

Methods and systems are provided, in an online advertising marketplace including publishers, advertisers and data providers, for allocating or partitioning, or automatically allocating or partitioning, advertiser payment, in connection with a purchase of advertising inventory, between a publisher and one or more data providers. Techniques are provided that seek to efficiently and fairly allocate the payment between the parties, taking into account value provided, such as by utilizing Shapley values. Provided techniques may also include efficiently or optimally integrating, facilitating, selecting or automating connections or arrangements between parties within the marketplace.

### BACKGROUND

Online advertising marketplaces and exchanges may involve, for example, entities or parties including advertisers, publishers and data providers, as well as a marketplace or online advertising operations facilitator, or market-maker. Data providers may supply information, such as information regarding users, user behavior or user interests, which may enhance value to advertisers in connection with purchasing of advertising inventory. However, in marketplaces and exchanges, significant difficulty and transactional friction may exist in selectivity, arrangements and cooperation between parties. This can lead to suboptimal interactions, reducing efficiency and disincentivizing maximum engagement and spending. Furthermore, friction as well as inequities or unfairness may exist in connection with pricing arrangement, actual pricing, and allocation of spend between parties including advertisers and data providers, and such as in connection with sold advertising inventory.

There is a need for improved techniques in online advertising, including in online advertising marketplaces and exchanges.

### SUMMARY

Some embodiments of the invention provide systems and methods, in an online advertising marketplace including publishers, advertisers and data providers, for allocating (which can include partitioning), or automatically allocating, advertiser payment (which can include a payment obligation), in connection with a purchase of advertising inventory, between a publisher and one or more data providers. Techniques are provided that seek to efficiently and fairly allocate the payment between the parties, taking into account value provided by each party, such as by utilizing Shapley values, and may also include payment to parties accordingly. Provided techniques may also include efficiently or optimally integrating, facilitating, selecting or automating connections or arrangements between parties within the marketplace. Some embodiments also include arranging efficient or optimal purchases, as well as determining advertiser pricing.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention;

FIG. 4 is a block diagram illustrating one embodiment of the invention; and

FIG. 5 is a block diagram illustrating one embodiment of the invention.

While the invention is described with reference to the above drawings, the drawings are intended to be illustrative, and the invention contemplates other embodiments within the spirit of the invention.

### DETAILED DESCRIPTION

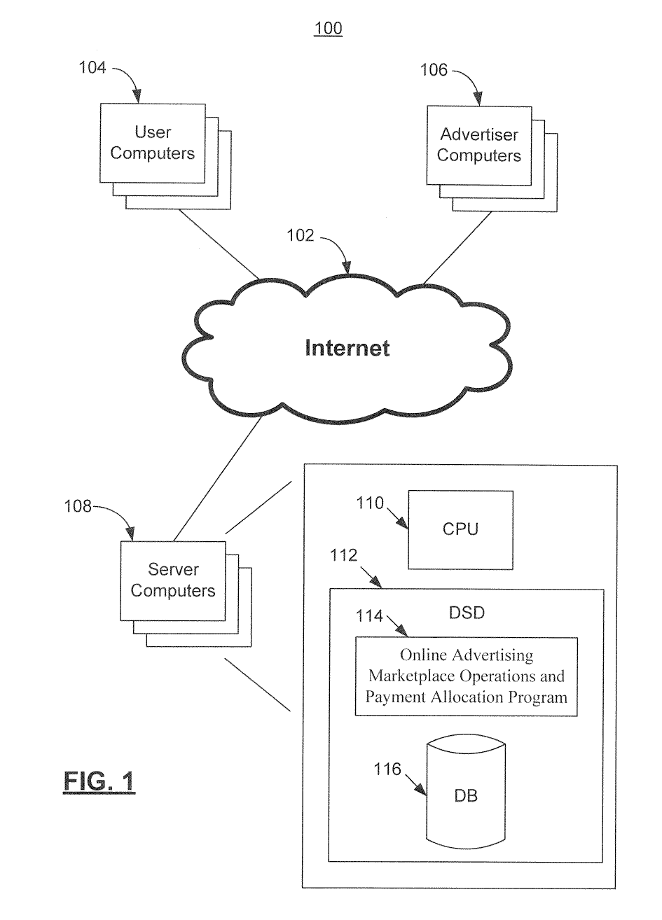

FIG. 1 is a distributed computer system 100 according to one embodiment of the invention. The system 100 includes user computers 104, advertiser computers 106 and server computers 108, all coupled or able to be coupled to the Internet 102. Although the Internet 102 is depicted, the invention contemplates other embodiments in which the Internet is not included, as ell as embodiments in which other networks are included in addition to the Internet, including one more wireless networks, WANs, LANs, telephone, cell phone, or other data networks, etc. The invention further contemplates embodiments in which user computers or other computers may be or include wireless, portable, or handheld devices such as cell phones, PDAs, etc.

Each of the one or more computers 104, 106, 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, rich advertisements, video advertisements, etc.

As depicted, each of the server computers 108 includes one or more CPUs 110 and a data storage device 112. The data storage device 112 includes a database 116 and an Online Advertising Marketplace Operations and Payment Allocation Program 114.

The Program 114 is intended to broadly include all programming, applications, algorithms, software and other and tools necessary to implement or facilitate methods and systems according to embodiments of the invention. The elements of the Program 114 may exist on a single server computer or be distributed among multiple computers or devices.

Some embodiments of the invention relate to monetization associated with advertising. Various monetization techniques or models may be used in connection with sponsored search advertising, including advertising associated with user search queries, and non-sponsored search advertising, including graphical or display advertising. In an auction-based online advertising marketplace, advertisers may bid in connection with placement of advertisements, although many other factors may also be included in determining advertisement selection or ranking. Bids may be associated with amounts the advertisers pay for certain specified occurrences, such as for placed or clicked-on advertisements, for example. Advertiser payment for online advertising may be divided between parties including one or more publishers or publisher networks, and one or more marketplace facilitators or providers, potentially among other parties.

Some models include guaranteed delivery advertising, in which advertisers may pay based on an agreement guaranteeing or providing some measure of assurance that the advertiser will receive a certain agreed upon amount of suitable advertising, and non-guaranteed delivery advertising, which may be individual serving opportunity-based or spot market-based. In various models, advertisers may pay based on any of various metrics associated with advertisement delivery or performance, or associated with measurement or approximation of a particular advertiser goal. For example, models can include, among other things, payment based on cost per impression or number of impressions, cost per click or number of clicks, cost per action for some specified action, cost per conversion or purchase, or cost based on some combination of metrics, which can include online or offline metrics.

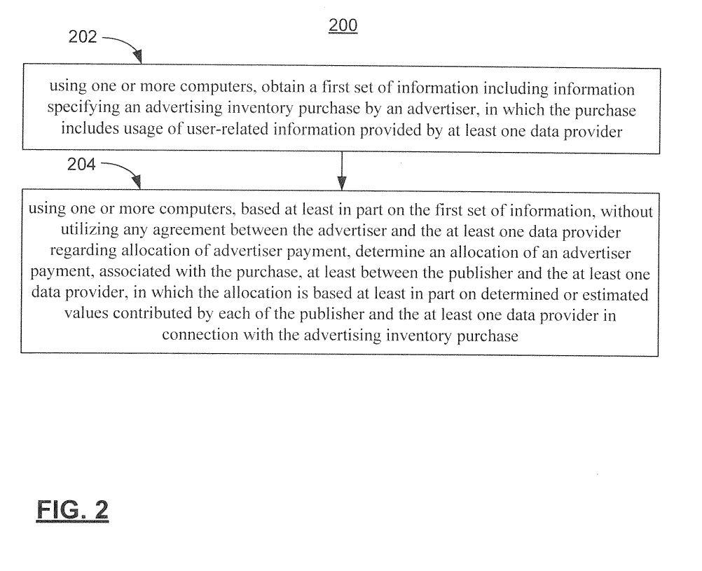

FIG. 2 is a flow diagram illustrating a method according to one embodiment of the invention. At step 202, using one or more computers, a first set of information is obtained, including information specifying an advertising inventory purchase by an advertiser, in which the purchase includes usage of user-related information provided by at least one data provider.

At step 204, using one or more computers, based at least in part on the first set of information, without utilizing any agreement between the advertiser and the at least one data provider regarding allocation of advertiser payment, an allocation is determined of an advertiser payment, associated with the purchase, at least between the publisher and the at least one data provider. The allocation is based at least in part on determined or estimated values contributed by each of the publisher and the at least one data provider in connection with the advertising inventory purchase.

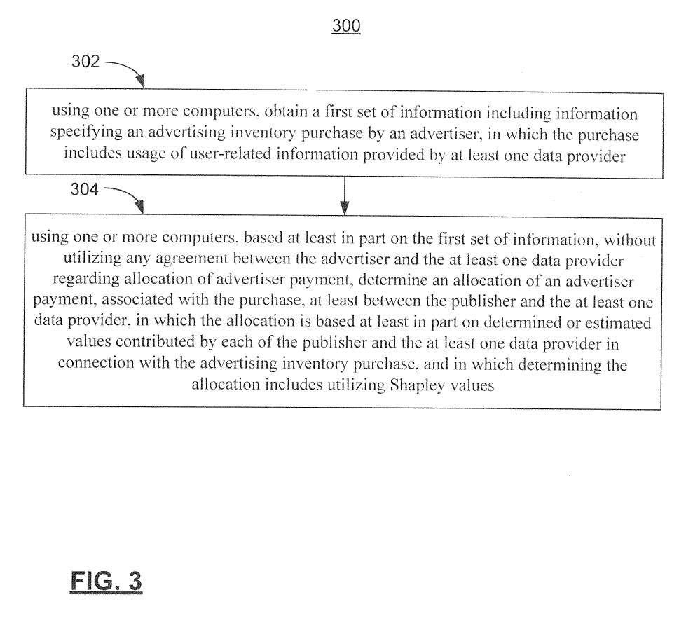

FIG. 3 is a flow diagram illustrating a method according to one embodiment of the invention. Step 302 is similar to step 202 as depicted in FIG. 2.

At step 304, using one or more computers, based a east in part on the first set of information, without utilizing any agreement between the advertiser and the at least one data provider regarding allocation of advertiser payment, an allocation is determined of an advertiser payment, associated with the purchase, at least between the publisher and the at least one data provider. The allocation is based at least in part on determined or estimated values contributed by each of the publisher and the at least one data provider in connection with the advertising inventory purchase. Furthermore, the allocation includes utilizing Shapley values.

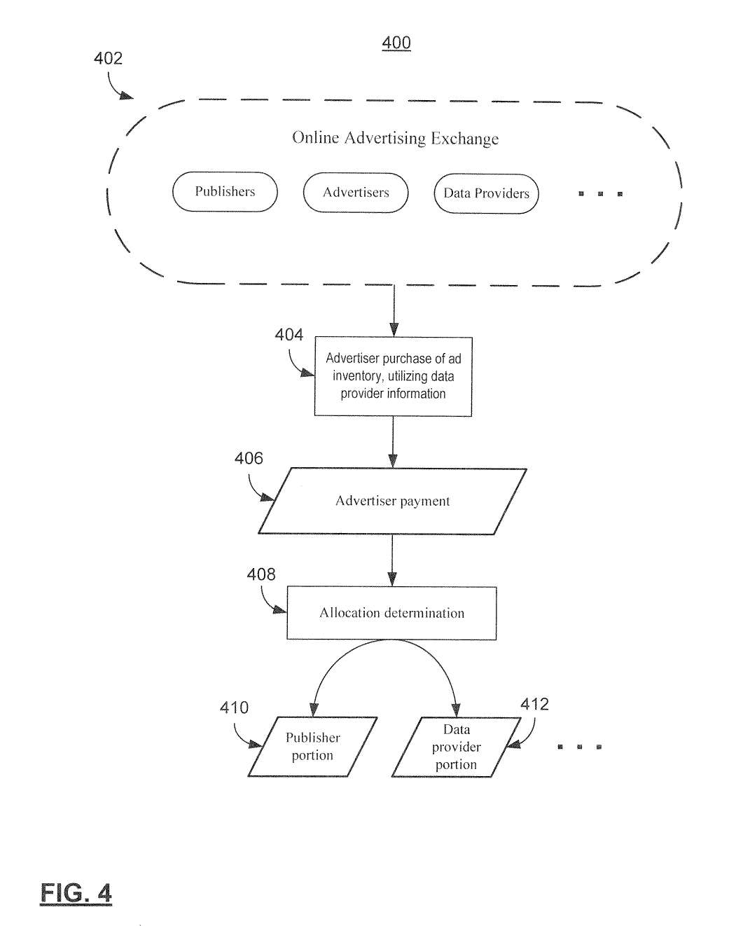

FIG. 4 is a block diagram illustrating one embodiment of the invention. Block 402 represents an advertising marketplace, such as an advertising exchange, including or linking entities such as publishers, advertisers and data providers. Other entities, and networks of entities, might also be linked or included. The marketplace 402 may be at least partially operated and managed by at least one market maker.

Block 404 represents advertiser purchase of advertising inventory, utilizing data provider information, such as user or targeting information.

Block 406 represents advertiser payment, or a payment obligation, associated with the purchase.

Block 408 represents an allocation determination relating to the payment or payment obligation associated with the purchase. It is to be understood that payments, payment allocations, allocation determinations, etc., may be handled in groups, in aggregate, etc., but, for illustration purposes, simple or simplified situations may be described.

Blocks 410 and 412 represent determined portions or proportions of payment for the advertiser and data provide (or each of the data providers) who provided information utilized in the purchase, such as labeling information relating to purchased advertising inventory. While a single data provider is depicted, it is to be understood that multiple data providers may be included, such as when multiple data providers provide information utilized in the purchase.

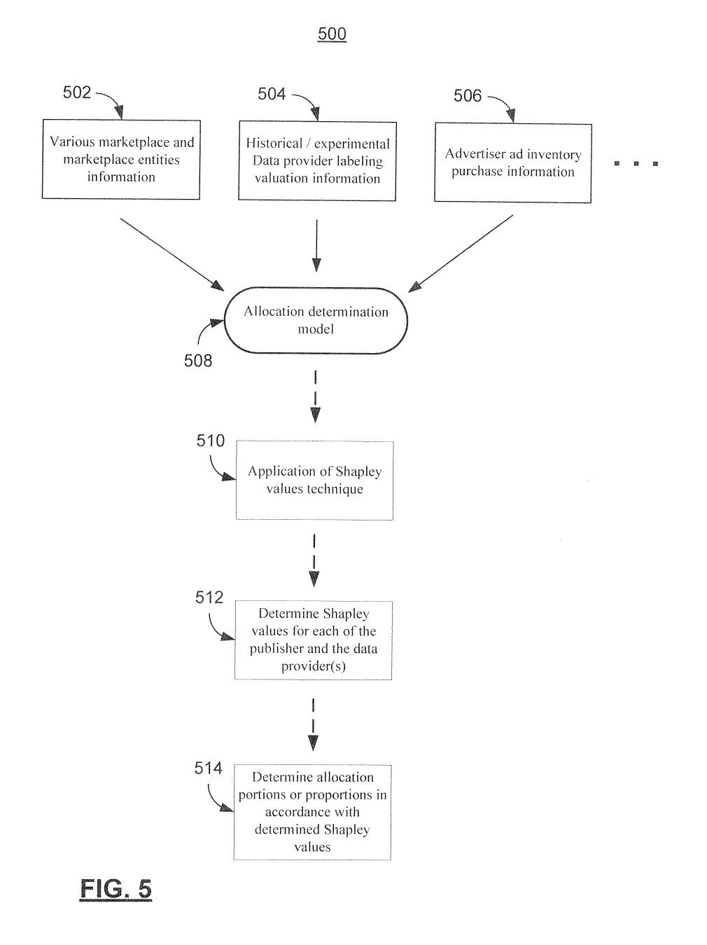

FIG. 5 is a block diagram illustrating one embodiment of the invention. An allocation determination model 508 is depicted, which can broadly represent or include algorithms, tools, techniques, machine learning techniques, etc. used in performing allocation determinations.

Various information is obtained by or input to the model 508. This information can include, among other things, various information regarding the marketplace and marketplace entities 502, historical or experimental data provider labeling valuation information 504, and information regarding one or more advertising inventory purchases by one or more advertisers 506.

Blocks 510, 512 and 514 represent steps performed zing the model 508. Also, blocks 512 or 514 may or may not be considered part of block 510.

Block 510 represents application of a Shapley values technique. It is to be understood embodiments of the invention can us any of various techniques in determining allocations, including techniques other than Shapley values techniques. Such techniques can include various techniques for equitable or fair allocations based on value provided, for example.

Block 512 represents determination of Shapley values for each of the publisher and the data providers associated with the purchase.

Block 514 represents determination of allocation portions or proportions in accordance with determined Shapley values.

Typically, in online advertising, advertisers bid to buy opportunities to advertise, which may be called ad calls, from publishers. In addition, third party data providers may use side information to label some ad calls, which may indicate that those ad calls offer greater value to some advertisers. Those advertisers may bid more for labeled ad calls.

In effect, those advertisers may purchase a combination of information from data providers and ad calls from publishers. Some embodiments of the invention provide a mechanism to partition advertiser payments among data providers and publishers. In some embodiments, the mechanism is based on Shapley values, and may be efficient, symmetric, and individually rational.

Some embodiments offer a mechanism to divide advertiser payment between data providers and publishers when advertisers buy ad calls using third-party data, from companies like Blue Kai and Exelate, for example. The mechanism may be designed to attract participation of third-party data suppliers by arranging automated valuation and payment to them. Increased participation can increase revenue including market maker revenue.

Some embodiments use Shapley values, which have been associated with cooperative game theory, for example, to credit third party data providers and publishers appropriately for the prices paid by advertisers. Shapley values are efficient, symmetric, and individually rational, and their use may help assure third party data providers of fair treatment, attracting or enhancing participation and marketplace activity.

In some embodiments, methods are provided that allow payments to be computed automatically rather than negotiated between third-party data suppliers and advertisers one by one. This can make it possible, for example, for a marketplace or market maker to go straight to use of third party data once determined that it is useful for an advertiser, without the friction of having to hammer out a deal between data provider and advertiser.

Some embodiments include a recognition that information generally improves buying and selling decisions, increasing efficiency in markets. In online advertising marketplaces, where advertisers may purchase ad calls from publishers, third party data providers label ad calls based on what may be termed side information. For example, a third party data provider may collect data on which users visit web sites related to deciding which car to purchase and then use the data to label as “car purchase interest” ad calls corresponding to those users, even when they are visiting websites unrelated to cars.

Continuing the car example, an advertiser who sells cars may want to use effective “car purchase interest” labels to select which ad calls to buy. Generally, it has been the case that the advertiser, data provider, and publisher, or their representatives, must discover each other, make payment arrangements, set up the needed data pipelines, and evaluate how effective the label is for the advertiser. This overhead can introduce inefficiency as advertisers may not discover the best data providers for their needs, and payments to data providers may not be linked with the value they provide.

Some embodiments can be used in providing an online advertising marketplace having a population of data providers, all labeling ad calls from all publishers in the marketplace. This integrated marketplace could then, for example, automatically perform experiments to determine how much value different combinations of labels and ad calls provide to different advertisers. For example, the advertisers could use this information to set bids on combinations of labels and ad calls, or the marketplace could set and adjust the bids on behalf of the advertisers. In this scenario, the market maker may need or desire to determine how to partition advertiser payments among data providers and publishers. Some embodiments provide a mechanism for such, based on Shapley values.

For example, in online display advertising marketplaces, ad calls may be awarded to advertisers based on auctions. There may be an auction for each ad call. The auction may use a second-price mechanism in an effort to induce truth-telling, for example. Advertisers may express targeted bids. For example, an advertiser may bid only on ad calls corresponding to males age 25 to 40 in New York City. Alternatively, an advertiser may bid more for those ad calls and less for others. With integrated data providers, advertisers could include data provider labels in their targeting for bids. For example, an advertiser could set a bid for males age 25 to 40 in New York City who are labeled as interested in buying a our according to either of two data providers and are labeled as credit-worthy by a third data provider. The market maker, for example, could connect advertisers to data providers in several ways. First, the market maker could suggest data providers to advertisers by matching items sold by advertisers with labels. Next, the marketplace could evaluate which labels provide the best return on investment, by observing how frequently different combinations of labels are associated with ad calls that prompt user responses to ads, such as clicks and sales. Alternatively, the market maker could automatically adjust bids for different combinations of labels on behalf of the advertisers.

In some embodiments, for example, use of Shapley values could include the following steps.

First, for each ad call, perform an auction over all bids with targeting conditions met by the ad call and labels. The auction awards the ad call to an advertiser and determines how much to charge the advertiser. That charge is the total revenue for the publisher and data providers.

Second, Let P be the publisher, and let D be the set of data providers who label the ad call and are referenced in the targeting for the winning bid. Define N as the set of cooperative players and v as a value function defined on any subset S⊂N, where v(S) defines the value generated by the set S independently, satisfying conditions necessary for Shapley value application. Apply Shapley values, with N=D∪P the set of cooperative players. Then v(S) is the revenue that would have been generated if only the players in S participated. Since the ad call is necessary to generate revenue, v(S)=0 if P∉S. For S⊃ {P}, to compute v(S), remove any labels provided by data providers in D\S and determine how much revenue resulting auction would generate (the resulting auction lacks bids that require the removed labels in their targeting). Allocate and pay each player in N that player's corresponding Shapley value.

While the invention is described with reference to the above drawings, the drawings are intended to be illustrative, and the invention contemplates other embodiments within the spirit of the invention.

1. In an online advertising marketplace comprising publishers, advertisers and data providers, a method comprising:
using one or more computers, obtaining a first set of information comprising information specifying an advertising inventory purchase by an advertiser, wherein the purchase includes usage of user-related information provided by at least one data provider; and
using one or more computers, based at least in part on the first set of information, without utilizing any agreement between the advertiser and the at least one data provider regarding allocation of advertiser payment, determining an allocation of an advertiser payment, associated with the purchase, at least between the publisher and the at least one data provider;
wherein the allocation is based at least in part on determined or estimated values contributed by each of the publisher and the at least one data provider in connection with the advertising inventory purchase.

2. The method of claim 1, wherein providing the user-related information comprises providing advertisement targeting information.

3. The method of claim 1, wherein determining the allocation comprises:
determining or estimating a value of the user-related information; and
determining the allocation based at least in part on the value.

4. The method of claim 1, determining the allocation comprises:
determining or estimating a value of the user-related information, comprising utilizing historical user and advertisement performance information; and
determining the allocation based at least in part on the value.

5. The method of claim 1, comprising determining the allocation such that greater value of the user-related information results in greater allocation amount to the at least one data provider.

6. The method of claim 1, comprising attempting to determine the allocation in a fair manner between the at least one data provider and the publisher.

7. The method of claim 1, herein the at least one data provider comprises two or more data providers, and comprising allocating the payment between parties including each of the two or more data providers.

8. The method of claim 1, comprising determining allocation utilizing Shapley values.

9. The method of claim 1, comprising determining the allocation utilizing Shapley values, wherein determined particular Shapley values correspond to particular allocations to each of the publisher and the at least one data provider.

10. The method of claim 1, comprising obtaining the first set of information, wherein the advertising inventory comprises at least one advertisement call associated with a serving opportunity.

11. The method of claim 1, wherein the marketplace is at least partially operated and at least partially managed by at least one market maker.

12. The method of claim 1, wherein the marketplace is at least partially operated and a least partially managed by at least one market maker, and wherein the at least one market maker implements the purchase on behalf of the advertiser.

13. The method of claim 1, wherein the marketplace is at least partially operated and at least partially managed by at least one market maker, and wherein the at least one market maker at least partially determines pricing for the purchase.

14. The method of claim 1, wherein the marketplace is at least partially operated and at least partially managed by at least one market maker, and wherein the at least one market maker selects the at least one data provider to provide the user-related information for the purchase.

15. A system comprising:
one or more server computers coupled to a network; and
one or more databases coupled to the one or more server computers;
wherein the one or more server computers are for, in an online advertising marketplace comprising publishers, advertisers and data providers:
obtaining a first set of information comprising information specifying an advertising inventory purchase by an advertiser relating to advertising inventory, wherein the purchase includes usage of user-related information provided by at least one data provider; and
based at least in part on the first set of information, without utilizing any agreement between the advertiser and the at least onc data provider regarding allocation of advertiser payment, determining an allocation of an advertiser payment, associated with the purchase, at least between the publisher and the at least one data provider;
wherein the allocation is based at least in part on determined or estimated values contributed by each of the publisher and the at least one data provider in connection with the advertising inventory purchase.

16. The system of claim 15, wherein a east one of the one or more server computers are coupled to an advertising exchange.

17. The system of claim 15, comprising assisting in distributing payments to each of the publisher and the at least one data provider in accordance with the allocation.

18. The system of claim 15, comprising determining the allocation utilizing Shapley values.

19. The system of claim 15, comprising determining the allocation utilizing Shapley values, wherein determined particular Shapley values correspond to particular allocations to each of the publisher and the at least one data provider.

20. A computer readable medium or media containing instructions for executing a method comprising, in an online advertising marketplace comprising publishers, advertisers and data providers:
using one or more computers, obtaining a first set of information comprising information specifying an advertising inventory purchase by an advertiser relating to advertising inventory, wherein the purchase includes usage of user-related information provided by at least one data provider; and
using one or more comp ers, based at least in part on the first set of information, without utilizing any agreement between the advertiser and the at least one data provider regarding allocation of advertiser payment, determining an allocation of an advertiser payment, associated with the purchase, at least between the publisher and the at least one data provider;
wherein the allocation is based at least in part on determined or estimated values contributed by each of the publisher and the at least one data provider in connection with the advertising inventory purchase;
and wherein determining the allocation comprises utilizing Shapley values.
